(19) United States
(12) Patent Application Publication
(10) Pub. No.: US 2007/0176949 A1
(43) Pub. Date: Aug. 2, 2007

(54) Dithering system

(75) Inventors: Wen-Chieh Chang, Hsin-Chu (TW); Yao-Jen Hsieh, Hsin-Chu (TW); Huan-Hsin Li, Hsin-Chu (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/698,092

(22) Filed: Jan. 26, 2007

(30) Foreign Application Priority Data
Jan. 27, 2006 (TW) 95103614

(51) Int. Cl. G09G 5/10

(52) U.S. Cl. 345/690

(57) ABSTRACT

Disclosured is a dithering system applied to a multimedia player. The dithering system comprises a pattern generator to generate video data; a processing unit to receive the video data as pre-processed by way of fixed-pattern and output; a timing controller to receive the output video data; and a dynamic index system comprising a pseudo-random generating unit and a dynamic pattern index generating unit, wherein the dynamic index system receives the video data provided by the timing controller, then a substantially random number is generated via the operation of the pseudo-random generating unit, continuously a dynamic pattern index is generated via the operation of the dynamic pattern index generating unit so as to allow the dynamic pattern index be the index of the dithering data.

### BACKGROUND OF THE INVENTION

1. Field of the Invention

The present invention relates to a dithering system, which is applied to the hue-extending technology of the digital image display field and, more particularly, to a system adopting random dynamic pattern indexes to achieve the effect of hue-extension.

2. Description of the Prior Art

Liquid crystal display (LCD) has the features of power-saving, low irradiation, slim weight/volume, etc. It results in that laptop has being broadly used. Hence, with the development of larger-dimensional liquid crystal panel, LCD is gradually applied to personal computer (PC), and therefore the traditional cathode-ray tube (CRT) is replaced as well. But the developed technology of LCD has being gone into the status of a bottleneck of the dynamic video recently.

The bottleneck is mainly about that the chromatic gradations cannot be truly displayed, such as general visible images; further, the color reproducibility of the display image is in aliasing while in high resolution. Therefore, how to solve the problem is an important issue for people skilled in the art.

The technology of hue-extension is the solution to the problem of unsatisfied saturation of color. It is applied to the digital image display field, more particularly to thin film transistor-liquid crystal display (TFT-LCD). The technology applied to TFT-LCD uses the principles of dithering and frame-rate-control (FRC), which cooperates with the vision synthesis and physiology of human being and adopt the technology of mixing color in the space to achieve the effect of hue-extension of vision of the human being.

Referring to FIG. 1A, which is a schematic view of a typical serial dithering system. The serial dithering system 1 is composed of a multimedia player 10, which includes a pattern generator 12. The pattern generator 12 has a processing unit 14, which is a display card or a processor with a timing controller (T-CON) 16. The timing controller 16 has a pattern index system 18. Generally speaking, the pattern generator 12 inputs video data to the processing unit 14, and thus the processing unit 14, which pre-processes the video data by way of fixed-pattern. The timing controller 16 outputs the pre-processed video data to the pattern index system 18 so as to continuously proceed with the procedures of the hue-extension of a downstream display device.

Referring to FIG. 1B, which is a schematic view of a pattern index system. The pattern index system 18 includes a data analysis unit 181, a pattern index table 182, and a data processing unit 183. The formerly dithering technology mostly adopts a fixed pattern index table 182 or namely a fixed pattern table. The pattern index table 182 is directly inputted or burned into the timing controller so as to be a basis for dithering images. The i bits of the video data pre-processed by way of the fixed-pattern are inputted into the data analysis unit 181. According to the video data look it up in the fixed pattern index table 182 and then the operation of the data processing unit 183 is made to output for the determination of the j bits of dithering data. Wherein j is smaller than or equal to i.

There are two disadvantages for using the fixed pattern index table are listed below: first, the reference value of an optimized pattern index is difficult to found out; second, while the front of the processing unit 14 simultaneously operates in the way of the fixed-pattern, the hue-extension of the downstream display device connected in series may then appear the unpredictable miscellaneous lines. Hence conspicuous stepped-type lines are caused during that the images are gradually changed. The conflict phenomenon of the serial dithering system seriously influences the quality of the images.

### SUMMARY OF THE INVENTION

In general, in one aspect, the present invention relates to provide a dithering system, which adopts random dynamic pattern indexes to achieve the result of hue-extension.

In general, in one aspect, the present invention relates to provide a dithering system, which efficiently solves the problem of the conflict effect of the hue-extension of an LCD and the hue-extension to be pre-processed by the way of fixed-pattern in series.

In general, in one aspect, the present invention relates to a dithering system. The dithering system, incorporating a multimedia player to generate a dithering data to a display device via the way of random dynamics comprises: a pattern generator to generate a video data; a processing unit, which is electrically connected to the pattern generator and receives the video data via pre-processed by way of fixed-pattern and output; a timing controller, which is electrically connected to the processing unit and receives the output video data; and a dynamic index system, which is electrically connected to the timing controller, has a pseudo-random generating unit and a dynamic pattern index generating unit, so as to receive the video data from the timing controller, so that to generate a substantially random number via the operation of the pseudo-random generating unit and a dynamic pattern index via the operation of the dynamic pattern index generating unit, and so as to allow the dynamic pattern index as the index of the dithering data.

In general, in one aspect, the present invention relates to a method for randomly and dynamically generating a pattern index incorporating a dynamic index system receives video data and processes each sub-pixel datum of the video data by a pseudo-random generating unit of the dynamic index system to alternately form dithering data of three dimensions of pixel, line, and frame, and the method comprises: providing the video data of substantially non-zero to the dynamic index system; receiving the video data and dynamically generating a substantially random number by the pseudo-random generating unit; selecting the m bits of the substantially random number as at least one target adapted to as a vector position code of a dynamic pattern index matrix; repeating the step of selecting the m bits of the substantially random number as at least one target adapted to as a vector position code of a dynamic pattern index matrix for M times so as to guide the acquired M sets of m bits as a row vector position code (M×1) of a dynamic pattern index matrix; and acquiring a two-dimensional dynamic pattern index matrix (M×N) according to the column vector position code (M×1) by operating of the pseudo-random generating unit.

### BRIEF DESCRIPTION OF THE DRAWINGS

The objects, spirits, and advantages of the preferred embodiments of the present invention will be readily understood by the accompanying drawings and detailed descriptions.

FIG. 1A is a schematic view of a typical serial dithering system;

FIG. 1B is a schematic view of a pattern index system in prior arts;

FIG. 2A illustrates a schematic view of a serial dithering system of the present invention;

FIG. 2B illustrates a schematic view of a dynamic index system of the present invention;

FIG. 3A illustrates a schematic view of a pseudo-random generating unit and a dynamic pattern index generating unit of the present invention;

FIG. 3B illustrates a schematic view of a linear feedback shift register of the pseudo-random generating unit of the present invention;

FIG. 4A is a schematic view of a 4-bit LFSR of the present invention;

FIG. 4B is a schematic view of a 16-bit LFSR of the present invention;

FIG. 4C is a schematic view of an 18-bit LFSR of the present invention;

FIG. 4D is a schematic view of a 12-bit LFSR of the present invention;

FIG. 5A illustrates a schematic view of random numbers grouped in the dynamic pattern index generating unit of the present invention;

FIG. 5B illustrates a schematic view of random numbers grouped in the dynamic pattern index generating unit of the present invention;

FIG. 5C illustrates a schematic view of random numbers grouped in the dynamic pattern index generating unit of the present invention;

FIG. 6A illustrates a dynamic pattern index matrix of the present invention;

FIG. 6B illustrates a dynamic pattern index matrix of the present invention;

FIG. 6A illustrates a dynamic pattern index matrix of the present invention;

FIG. 7 illustrates a diagram of a way to generate targets and randomization of the dynamic pattern index matrix of the present invention;

FIG. 8A illustrates a schematic view of color bars on a display of a prior art;

FIG. 8B illustrates a schematic view of color bars on a display of the present invention;

FIG. 8C illustrates a schematic view of a blue sky image on a display of a prior art;

FIG. 8D illustrates a schematic view of a blue sky image on a is display of the present invention;

FIG. 9A and FIG. 9B individually illustrate two schematic views of appearing unpredicted contours along the horizontal and the vertical directions of the serial dithering system in prior arts; and

FIG. 9C and FIG. 9D individually illustrate two schematic views of images along the horizontal and the vertical directions of the serial dithering system of the present invention.

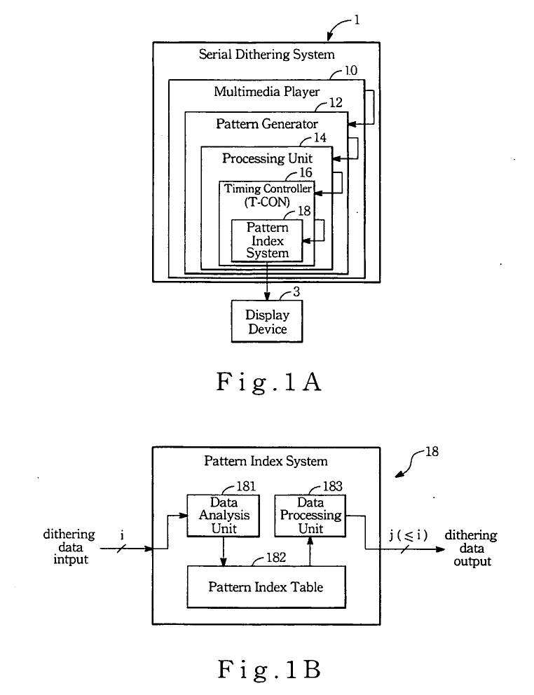

### DETAILED DESCRIPTION OF THE INVENTION

The present invention provides a random dynamic pattern index. A plurality of new dynamic pattern index matrix tables are dynamically generated during the time intervals of changing pictures.

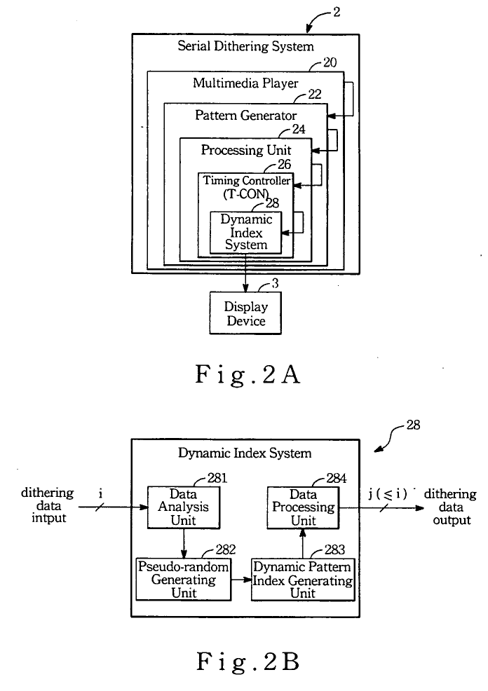

Referring to FIG. 2A, which is a schematic view of a serial dithering system of the present invention. The serial dithering 2 includes a multimedia player 20. The multimedia player 20 includes a pattern generator 22. The pattern generator 22 includes a processing unit 24. The processing unit 24 includes a timing controller (T-CON) 26. The timing controller 26 includes a dynamic index system 28.

Referring to FIG. 2B, which is a schematic view of the dynamic index system of the present invention. The dynamic index system 28 includes a data analysis unit 281, a pseudo-random generating unit 282, a dynamic pattern index generating unit 283, and a data processing unit 284. Wherein the data analysis unit 281 receives i-bit video data from the timing controller 26. The video data as the sub-pixel form of the video data are transmitted to the pseudo-random generating unit 282. Each pixel is defined at least three sub-pixels comprising red (R) sub-pixel, green (G) sub-pixel, and blue (B) sub-pixel or yellow (Y) sub-pixel, cyan (C) sub-pixel, and magenta (M) sub-pixel so as to represent the color of each pixel, but not limit it. On the other hand, each pixel is defined at least four sub-pixels comprising red (R) sub-pixel, green (G) sub-pixel, blue (B) sub-pixel, and a fourth sub-pixel. The color of the fourth sub-pixel can be any color, such as red (R), green (G), blue (B), yellow (Y), violet (V), indigo (I), magenta (M), cyan (C), colorless, or the like. Nevertheless, each pixel can also be defined at least six or eight sub-pixels, and the arrangement and colors of each sub-pixel can be determined by a user.

The pseudo-random generating unit 282 includes a plurality of linear feedback shift register (LFSR), and therefore generates substantially random numbers, which are transmitted to the dynamic pattern index generating unit 283. The dynamic pattern index generating unit 283 according to the substantially random numbers to generate a dynamic pattern index matrix is transmitted to the data processing unit 284. And then the data processing unit 284 transmits a plurality of j-bit dithering data, wherein i is substantially greater than or equal to j.

The substantially random number generated by the present invention is a substantially uniformly random number. And, the dynamic pattern index matrix derived by such substantially random numbers is the basis of the dithering data. While the dithering data are in one frame, each frame, or a plurality of frames for dithering calculation, which is applied to the pixel presentation of changing the frame or the plurality of frames and can be a reference for updating images. Wherein the dithering effect of the dithering data may scattered the contour of one frame, each frame, the frames. If the image is plus the substantially uniform random numbers of the dynamic pattern index matrix, so that the boundaries of digital images may be substantially soft. Constructing the image with three dimensions of pixel, line, and frame is based on the dithering data, therefore the digital colors shall be represented by fewer bits to show the digital colors shall be represented by greater bits so as to achieve a better quality of the image.

A plurality of embodiments describe the generation of the substantially random number and the derivation of the dynamic pattern index matrix from the substantially random number, and are listed below, but not limited. If the other method can be to generate the substantially random number of the present invention can be incorporating the present invention.

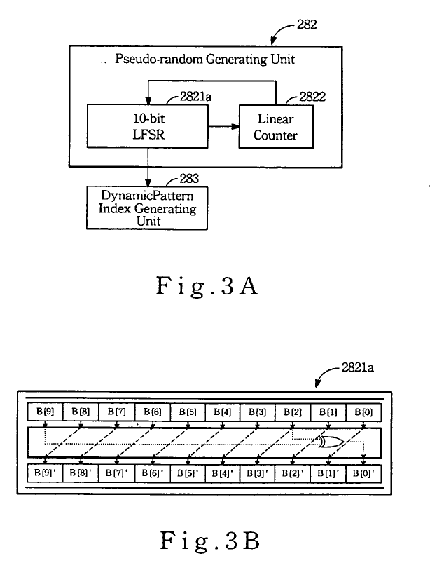

Referring to FIG. 3A and FIG. 3B simultaneously, which illustrate a schematic view of the pseudo-random generating unit, the dynamic pattern index generating unit of the present invention, and a schematic view of the linear feedback shift register of the present invention, respectively. The pseudo-random generating unit 282 includes at least one linear feedback shift register 2821a (hereinafter called LFSR) and one counter 2822. In the present embodiment, the LFSR 2821a is 10-bit, and the pseudo-random generating unit 282 will be described in detail by that.

Again, with the present embodiment, the LFSR 2821a receives the video data and engages in one of the way of the operation of XOR and the operation of mutual exclusion for the video data so as to generate a bit sequence with a great period. The steps of generating the substantially random number comprise: receiving the video data to be as an initial value of the LFSR 2821a to generate the substantially random numbers, wherein if the video data is substantially zero, both outputted values of the substantially random number and the dithering data are zeros, if the video data is substantially non-zero, the dithering data is the initial value of the LFSR 2821a, the video data is a digital signal with 10-bit, and the signals from the lowest bit to the highest bit of the video data are the order of B[0], B[1], B[2], B[3], B[4], B[5], B[6], B[7], B[8], and B[9], one of the way of the operation of XOR and the operation of mutual exclusion of the B[2] and B[9] results as B[0]′ is one of the substantially random numbers, thereafter the initial values of B[0], B[1], B[2], B[3], B[4], B[5], B[6], B[7], and B[8] can be as B[1]′, B[2]′, B[3]′, B[4]′, B[5]′, B[6]′, B[7]′, B[8]′, and B[9]′of the substantially random numbers. Thus, a new substantially random number is generated. The generated substantially random number is decided whether to add 1 to the dithering data or not by a line counter, and then the generated substantially random number is fed back to the LFSR 2821a. The LFSR 2821a transmits the generated substantially random number to the dynamic pattern index generating unit 283 to dither the generated substantially random number and allows the generated substantially random number be as a new initial value of the LFSR 2821a.

With the description in above paragraph, the circulation is continuous for more new substantially random numbers. The substantially random number has the features of following points of (for example: 10 bit):

(1) each substantially random number being in the scope substantially smaller than or substantially equal to 2, which means that the substantially random number is an integer between 1 and 1023 (including 1 and 1023);
(2) the period being 1023 times, which is not including the possibility of 0, that is, any integer between 1 and 1023 (including 1 and 1023), may be appeared once; and

(3) if the sequence of the substantially random number is longer, the appearing possibility of each integer between 1 and 1023 (1 and 1023), may endless approach to a value, which is 1/1023.

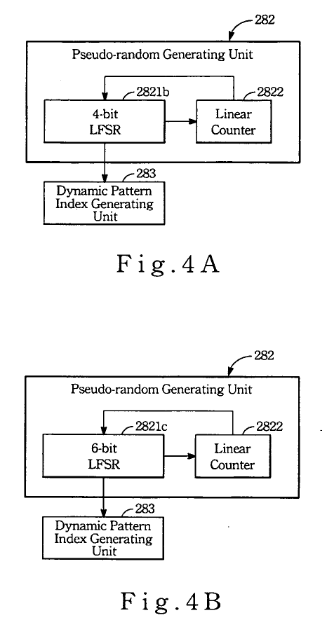

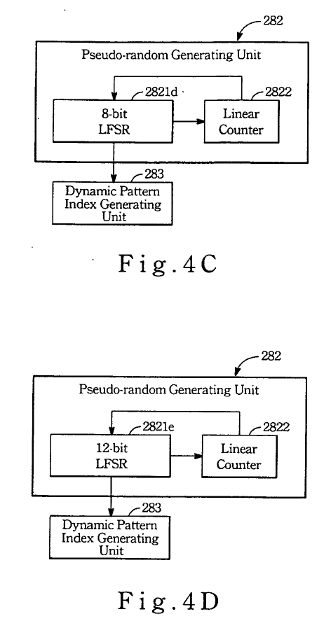

The dynamic index system can receive not only the 10-bit video data but also other video data with different bits. Referring to FIG. 4A, FIG. 4B, FIG. 4C, and FIG. 4D, which illustrate schematic views of the LFSRs receiving different bits of the video data in the pseudo-random generating unit of the present invention. FIG. 4A is a schematic view of a 4-bit LFSR. FIG. 4B is a schematic view of a 16-bit LFSR. FIG. 4C is a schematic view of an 18-bit LFSR. FIG. 4D is a schematic view of a 12-bit LFSR. The way of generating a substantially random number is described as in FIG. 3, and it will not be described any further.

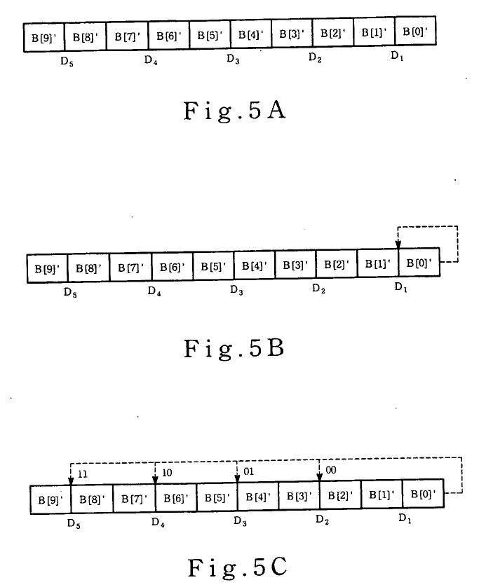

Referring to FIG. 5A, which illustrates a schematic view of a embodiment of substantially random numbers groups in the dynamic pattern index generating unit of the present invention. The substantially random number comprises a plurality of Dn sets of bits, n is 1 to N, each of D₁ to Dn includes m bits. For the present embodiment, the order of the lowest bit to the highest bit is B[0]′, B[1]′, B[2]′, B[3]′, B[4]′, B[5]′, B[6]′, B[7]′, B[8]′, and B[9]′. And the present embodiment is defined five sets, which are D₁, D₂, D₃, D₄, and D₅. Each set has 2 bits, that is, D₁ has B[1]′ and B[0]′, D₂ has B[3]′ and B[2]′, etc. The definitions as mentioned above is not to limit the scope of the present invention and is variable according to demands.

The dynamic pattern index generating unit may define a set, called Dx, as a target, x is 1 to N, or define a set, called Dy, as a guide to indicate an acquired Dx to be the target, wherein x is 1 to N and y is 1 to N. As an example, in FIG. 5B, taking D₁ from the substantially random number as a target (herein called a) and so as to allow the target be a position code (PosCode) of follow-up generating a dynamic pattern index. Or, in FIG. 5C, two bits of D1 are to be a guide to indicate the acquired index to a certain set. In the present embodiment, while two bits of D1 are 00, the two bits are guided to D₂ as a target. Again, while two bits of D₁ are 01, the two bits are guided to D₃ as a target. Again, while two bits of D₁ are 10, the two bits are guided to D₄ as a target. Again, while two bits of D₁ are 11, the two bits are guided to D₅ as a target. And repeating the procedure, other PosCodes (such b, c, d, . . . , etc) are then updated. Hence, a column vector position code (M×1) is generated so as to derive an M×N dynamic pattern index matrix. Accordingly a row vector position code (1×N) is produced in order to produce another M×N dynamic pattern index matrix. Or, when a target is defined, the target is in a row calculation to generate a row vector, and then repeating the procedures is able to result in a plurality of row vectors so as to form the M×N dynamic pattern index matrix.

A method for randomly and dynamically producing a pattern index comprising the steps of: providing the video data of substantially non-zero to a dynamic index system; receiving the video data and dynamically generating a substantially random number by the pseudo-random generating unit; selecting the m bits of the substantially random number as at least one target adapted to as a vector position code (such as (1,1), or likes) of a dynamic pattern index matrix; repeating the step of selecting the m bits of the substantially random number as at least one target adapted to as a position code of a dynamic pattern index matrix for M times so as to guide the acquired M sets of m bits as a column vector position code (M×1) of the dynamic pattern index matrix; and acquiring a two-dimensional dynamic pattern index matrix (M×N) according to the column vector position code (M×1) by operating of the pseudo-random generating unit.

Or other method to generate the pattern index by way of a row calculation comprises the steps of: providing the video data of substantially non-zero to the dynamic index system; receiving the video data and dynamically generating the substantially random number by the pseudo-random generating unit; selecting the m bits of the substantially random number as at least one target adapted to as the position code (such as (1,1), or likes) of the dynamic pattern index matrix; repeating the step of selecting the m bits of the substantially random number as at least one target adapted to as a position code of a dynamic pattern index matrix for N times so as to guide the acquired N sets of m bits as a row vector position code (1×N) of the dynamic pattern index matrix; and acquiring a two-dimensional dynamic pattern index matrix (M×N) according to the row vector position code (1×N) by operating of the pseudo-random generating unit.

Or another method comprises the steps of: providing the video data of substantially non-zero to the dynamic index system; receiving the video data and dynamically generating the substantially random number by the pseudo-random generating unit; selecting the m bits of the substantially random number as at least one target; selecting the plurality of targets as the vector position code (such as (1,1), or likes) of the dynamic pattern index matrix; operating the vector position code (such as (1,1), or likes) by way of the row calculation to form the row vector; repeating the step of selecting the plurality of targets for M times and generating M rows of row vectors according to the operation of each position code; and generating the two-dimensional dynamic pattern index matrix (M×N) by way of arranging the M rows of row vectors in serials.

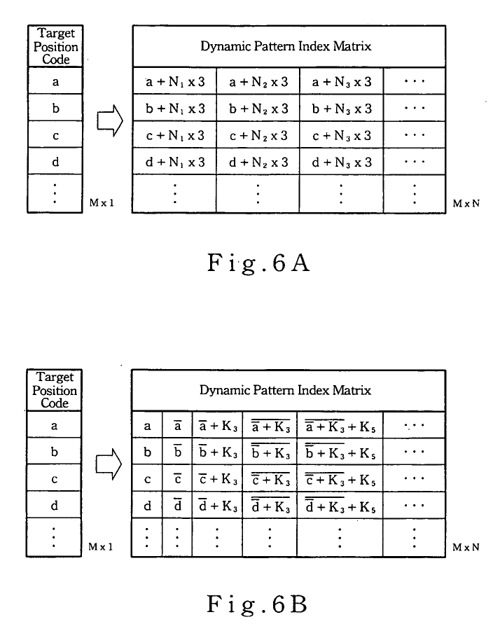

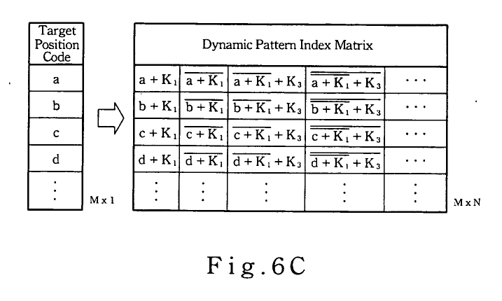

Referring to FIG. 6A, which illustrates a embodiment of the dynamic pattern index matrix of the present invention. Wherein the column vector position code (M×1) plus a predetermined number (such as Nn*3, or the like) is the n^{th} row of the dynamic pattern index matrix (M×N), n is 1 to N. For example, the (4×4) dynamic pattern index matrix, wherein the targets of a being as 00, b being as 01, c being as 10, and d being as 11, and the predetermined numbers of N₁ being as [00], N₂ being as [01], N₃ being as [10], and N₄ being as [11]. The (4×1) column vector position code composed of a, b, c, and d plus [00]*3 is as the first column. The column vector position code plus [01]*3 is as the second column. The column vector position code plus [10]*3 is as the third column. The column vector position code plus [11]*3 is as the fourth row.

Referring to FIG. 6B, which illustrates a embodiment of the dynamic pattern index matrix of the present invention. Wherein the column vector position code (M×1) is as the first column of the dynamic pattern index matrix (M×N), a ones complement of the first column is as the second column, the second column plus a predetermined value of K₃ is as the third column, another ones complement of the third column is as the fourth column, the fourth column plus a predetermined value of K₅ is as the fifth column, and logically a ones complement of the (2n−1)^{th} column is as the (2n)^{th} column, then the (2n)^{th} column plus a predetermined value of K₂ₙ₊₁ is as the (2n+1)^{th} column, n is 1 to N. The dynamic pattern index matrix is thus formed. By exemplary, the one complement of the column comprises an anti-phase of the column, or the like.

With an example supporting the above-mentioned embodiment, the (4×4) dynamic pattern index matrix has the targets of a being as 00, b being as 01, c being as 10, and d being as 11, and the predetermined value of K₃ being as [10]. The column vector position code composed of a, b, c, and d is as the first column, a ones complement of the first column is as the second column, the second column plus the predetermined value of K₃ being as [10] is as the third column, a ones complement of the third column is as the fourth column. By exemplary, the ones complement of the column comprises an anti-phase of the column, but not limited it.

Referring to FIG. 6C, which illustrates a embodiment of the dynamic pattern index matrix of the present invention. The (M×1) column vector position code plus the predetermined value of K₁ is as the first column of the dynamic pattern index matrix, a ones complement of the first column is as the second column, the second column plus the predetermined value of K₃ is as the third column, a ones complement of the third column is as the fourth column, the fourth column plus the predetermined value of K₄ is as the fifth column, therefore the (M×1) column vector position code plus the predetermined value of K₂ₙ₋₁ is as the (2n−1)^{th} column, a ones complement of the (2n−1)^{th} column is as the 2 n^{th} column, the 2 n^{th} column plus the predetermined value of K₂ₙ₋₁ is as the (2n+1)^{th} column, n is 1 to N. The dynamic pattern index matrix is thus formed. By exemplary, the one complement of the column comprises an anti-phase of the column, or likes.

With an example supporting the above-mentioned embodiment, the (4×4) dynamic pattern index matrix has the targets of a being as 00, b being as 01, c being as 10, and d being as 11, and the predetermined value of K₁ being as [10]. The row vector position code composed of a, b, c, and d plus the predetermined value (such as K₁ being as [10]) is as the first column, a ones complement of the first column is as the second column, the second column plus the predetermined value of K₃ being as [10] is the third column, a ones complement of the third column is as the fourth column. By exemplary, the one complement of the column comprises an anti-phase of the column, or likes.

The three embodiments illustrated in FIG. 6A, FIG. 6B, and FIG. 6C adopt the column vector position code to form the dynamic pattern index matrix, and are not to limit the scope of the present invention. The (1×N) row vector position code can replace the (M×1) column vector position code so as to generate the (M×N) dynamic pattern index matrix according to the same calculation. On the other hand, each position code is in the row calculation, then the derived rows are arranged to form the (M×N) dynamic pattern index matrix.

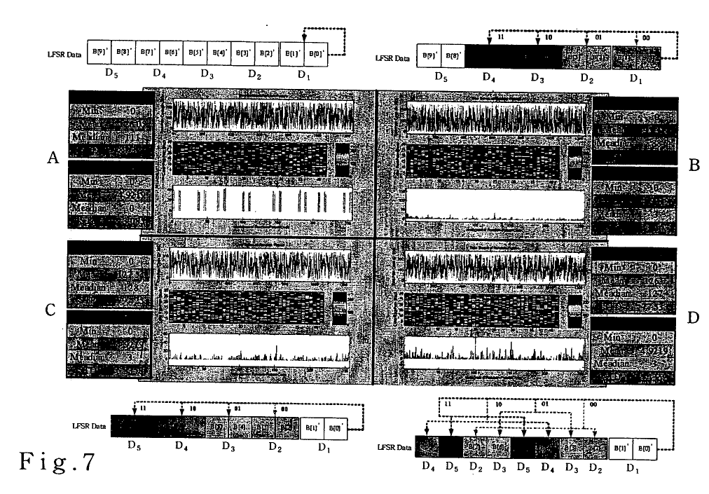

Referring to FIG. 7, which illustrates a diagram of a way to generate the targets and randomization of the dynamic pattern index matrix of the present invention. The derivation of the position code is related to that whether the randomization of the dithering dynamic index variation is even enough or not.

There are four ways to generate the targets so as to determine the position codes. The line statistic chart is able to present whether the randomization is uniformly or not. Normally the more even, the more ideal.

As shown in FIG. 7A, the way of generating the target is to randomly select any set, temporarily named D₁, of the substantially random numbers to be as a target, which is the basis of the position code of follow-up generating the dynamic pattern index. The randomization is not uniform.

As shown in FIG. 7B, the way of producing the target is to randomly select any set, temporarily named D₁, of the substantially random numbers to be as a guide, which indicates the acquired target to a certain set. That is, while D₁ is 11, then D₄ is a target; D₁ is 10, D₃ is a target; D₁ is 01, D₂ is a target; and D₁ is 00, D₁ itself is a target. Therefore, they are the bases of the position codes of follow-up generating the dynamic pattern index. The randomization is more even than FIG. 7A.

As shown in FIG. 7C, the theory of generating the target is similar to FIG. 7B. The only difference is that D₁ is purely a guide. That is, while D₁ is 11, then D₅ is a target; D₁ is 10, D₄ is a target; D₁ is 01, D₃ is a target; and D₁ is 00, D₂ is a target. The randomization is more even than FIG. 7A.

As shown in FIG. 7D, the substantially random numbers are defined five sets. D₁ represents B[1]′ and B[0]′; D₂ represents B[7]′ and B[2]′; D₃ represents B[6]′ and B[3]′; D₄ represents B[9]′ and B[4]′; and D₅ represents B[8]′ and B[5]′. D₁ is a guide, and while D₁ is 11, then D₅ is a target; D₁ is 10, D₄ is a target; D₁ is 01, D₃ is a target; D₁ is 00, D₂ is a target. The randomization is more even than FIG. 7A.

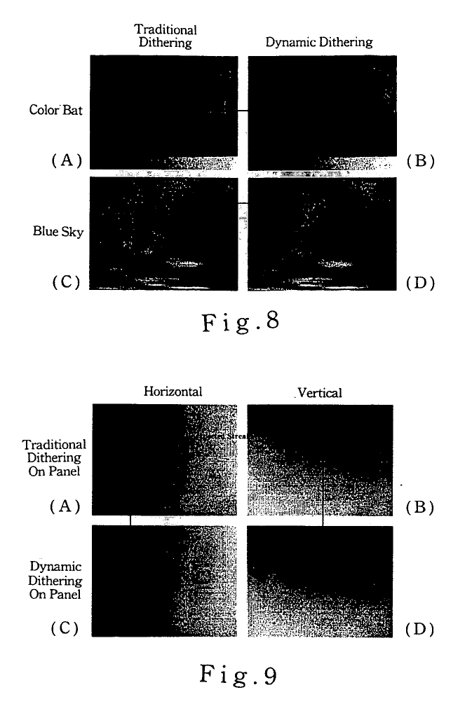

As shown in FIG. 8A and FIG. 8B, which illustrate two schematic views of color bars on two displays of a traditional art and the present invention, respectively. FIG. 8A shows the real colors after going through traditional dithering technology, and the 6-bit vertical gray-scale strips are very obvious. On the contrary, FIG. 8B shows that the gray-scale strips are disappeared due to the dynamic dithering, and the colors are 8-bit.

As shown in FIG. 8C and FIG. 8D, which illustrate two schematic views of blue sky images on two displays of a traditional art and the present invention, respectively. Comparing FIG. 8D with FIG. 8C, the blue sky image with the processes of the dynamic dithering of the present invention has no such irregular contours as shown in FIG. 8C. It seems that the blue sky image approach the effect of hue-extension.

As shown in FIG. 9A and FIG. 9B, which two schematic views of two conflict phenomena of two images along the vertical and the horizontal directions after going through two fixed-patterns of the serial dithering system in traditional arts, respectively. It seems that the unpredicted contours are appeared. Such problem is often happened and can not be allowed. On the other hand, as shown in FIG. 9C and FIG. 9D, which adopt the serial dithering system of the present invention so as to solve the traditional problem.

With the preferred embodiments as aforesaid, the present invention uses the dynamic index system to approach the effect of hue-extension. That is, the digital colors shall be represented by fewer bits so as to achieve a better quality of the image. The cascade of the LCD fixed-pattern and the pre-processed fixed-pattern is totally solved.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A dynamic index system electrically connected to a display panel received a dithering data therefrom according to signals of a timing controller (T-CON), comprising:
a pseudo-random generating unit to generate a substantially random number; and
a dynamic pattern index generating unit to select the m bits of the random number as at least one target, and to acquire the plurality of targets as a vector position code, which generates a dynamic pattern index matrix (M×N) by operations thereof.

2. The dynamic index system according to claim 1, wherein the pseudo-random generating unit comprises a linear feedback shift register.

3. The dynamic index system according to claim 2, wherein the linear feedback shift register produces the substantially random number by one of the ways of the operation of XOR and the operation of mutual exclusion.

4. The dynamic index system according to claim 1, wherein the substantially random number comprises a plurality of Dn sets of bits, n is 1 to N, each of D₁ to Dn includes m bits, and one of D₁ to Dn is as a target Dx, x is 1 to N.

5. The dynamic index system according to claim 1, wherein the substantially random number comprises a plurality of Dn sets of bits, n is 1 to N, each of D₁ to Dn includes m bits, and one of D₁ to Dn is as a guide Dy to indicate an acquired Dx to be the target, x is 1 to N and y is 1 to N.

6. The dynamic index system according to claim 1, wherein the pseudo-random generating unit generates the substantially random number by one of the way of the operation of XOR and the operation of mutual exclusion.

7. The dynamic index system according to claim 1, wherein the vector position code comprises a column vector position code (M×1).

8. The dynamic index system according to claim 7, wherein the column vector position code (M×1) plus a predetermined number of Nn*3 is as the n^{th} column of the dynamic pattern index matrix (M×N), n is 1 to N.

9. The dynamic index system according to claim 1, wherein the column vector position code (M×1) is as the first column of the dynamic pattern index matrix (M×N), a ones complement of the first column is as the second column, the second column plus a predetermined value of K₁ is as the third column, another ones complement of the third column is as the fourth column, a ones complement of the (2n−1)^{th} column is as the (2n)^{th} column, and then plus a predetermined value of K₂ₙ₊₁ is as the (2n+1)^{th} column, n is 1 to (N/2−1).

10. The dynamic index system according to claim 1, wherein the vector position code is as a row vector position code (1×N).

11. The dynamic index system according to claim 10, wherein the row vector position code (1×N) plus a predetermined number of Nn*3 is as the n^{th} row of the dynamic pattern index matrix (M×N), n is 1 to N.

12. The dynamic index system according to claim 10, wherein the row vector position code (1×N) is as the first row of the dynamic pattern index matrix (M×N), a ones complement of the first row is as the second row, the second row plus a predetermined value of K₁ is as the third row, another ones complement of the third row is as the fourth row, a ones complement of the (2n−1)^{th} row is as the (2n)^{th} row, and then plus a predetermined value of Kn as the (2n+1)^{th} row, n is 1 to (N/2-1).

13. A method for randomly and dynamically generating a pattern index incorporated in a dynamic index system receives video data and processes each sub-pixel datum of the video data by a pseudo-random generating unit of the dynamic index system to alternately form dithering data of three dimensions of pixel, line, and frame, the method comprising:
providing the video data of substantially non-zero to the dynamic index system;
receiving the video data and dynamically to generate a substantially random number by the pseudo-random generating unit;
selecting the m bits of the substantially random number as at least one target adapted to as a vector position code of a dynamic pattern index matrix;
repeating the step of selecting the m bits of the substantially random number as at least one target adapted to be as a vector position code of a dynamic pattern index matrix for M times so as to guide the acquired M sets of m bits as a column vector position code (M×1) of the dynamic pattern index matrix; and
acquiring a two-dimensional dynamic pattern index matrix (M×N) according to the column vector position code (M×1) by operating of the pseudo-random generating unit.

14. The method according to claim 13, wherein the pseudo-random generating unit comprises a linear feedback shift register.

15. The method according to claim 14, wherein the substantially random number is generated by that the video data is in one of the operation of XOR and the operation of mutual exclusion of the linear feedback shift register.

16. The method according to claim 13, wherein the substantially random number is generated by that the video data is in one of the operation of XOR and the operation of mutual exclusion of the pseudo-random generating unit.

17. The method according to claim 13, wherein the substantially random number comprise a plurality of Dn sets of bits, n is 1 to N, each of D₁ to Dn includes m bits, and one of D₁ to Dn is as a target Dx, x is 1 to N.

18. The method according to claim 13, wherein the substantially random number comprises a plurality of Dn sets of bits, n is 1 to N, each of D₁ to Dn includes m bits, and one of D₁ to Dn as a guide Dy is adapted to guide an acquired Dx to be the target, x is 1 to N and y is 1 to N.

19. The method according to claim 13, wherein the two-dimensional dynamic pattern index matrix (M×N) is that the column vector position code (M×1) plus a predetermined number of Nn*3 is as the n^{th} column of the dynamic pattern index matrix (M×N), n is 1 to N.

20. A dithering system incorporating to a multimedia player to produce a dithering data to a display device via the way of random dynamics, comprising:
a pattern generator to produce a video data;
a processing unit, electrically connected to the pattern generator, and to receive the video data via pre-processed by way of fixed-pattern and output;
a timing controller electrically connected to the processing unit and to receive the output video data; and
a dynamic index system, electrically connected to the timing controller, having a pseudo-random generating unit and a dynamic pattern index generating unit, so as to receive the video data from the timing controller, so that to generate a substantially random number via the operation of the pseudo-random generating unit and a dynamic pattern index via the operation of the dynamic pattern index generating unit, and so as to allow the dynamic pattern index as the index of the dithering data.
